(19) United States
(12) Patent Application Publication
(10) Pub. No.: US 2026/0310808 A1
(43) Pub. Date: Oct. 8, 2026

(54) OPTIMIZED AUXILIARY DATA UTILIZATION IN A MULTI-CLOUD ENVIRONMENT

(71) Applicant: DELL PRODUCTS L.P., Round Rock, TX (US)

(72) Inventors: Avinash Kumar, Patna (IN); Parminder Singh Sethi, Ludhiana (IN); Praveen Kumar, Noida (IN)

(21) Appl. No.: 19/169,660

(22) Filed: Apr. 3, 2025

(51) Int. Cl. G06F 21/62

(52) U.S. Cl. CPC G06F 21/6218

(57) ABSTRACT

An information handling system includes a data vault that stores protected data and provides auxiliary data associated with the protected data. The system tags elements of the auxiliary data to elements of the protected data, marks each tagged element of the auxiliary data with a relevance level that indicates a relevance of the element of the auxiliary data to the protection of the associated element of protected data, sets a relevance level threshold, retains a first set of the tagged elements in a storage device, and discards a second set of the tagged elements. The first set of the tagged elements has relevance levels higher than the relevance level threshold, and the second set of the tagged elements has relevance levels lower than the relevance level threshold.

### FIELD OF THE DISCLOSURE

This disclosure relates to information handling systems, and more particularly relates to providing optimized auxiliary data utilization in a multi-cloud environment.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a data vault that stores protected data and provide auxiliary data associated with the protected data. The system may tag elements of the auxiliary data to elements of the protected data, mark each tagged element of the auxiliary data with a relevance level that indicates a relevance of the element of the auxiliary data to the protection of the associated element of protected data, set a relevance level threshold, retain a first set of the tagged elements in a storage device, and discard a second set of the tagged elements. The first set of the tagged elements may have relevance levels higher than the relevance level threshold, and the second set of the tagged elements may have relevance levels lower than the relevance level threshold.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method for optimizing auxiliary data in a multi-cloud environment according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

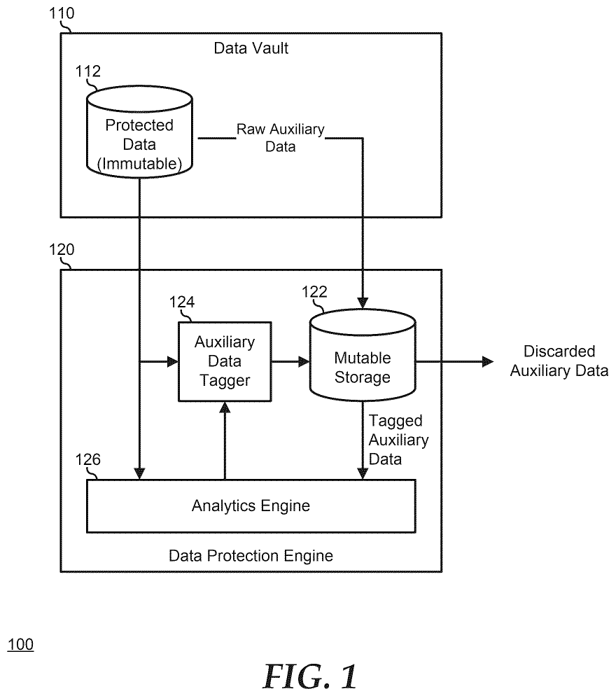

FIG. 1 illustrates an information handling system 100 similar to information handling system 300 as described below. Information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components

Information handling system 100 includes a data vault 110 and a data protection engine 120. Data vault 110 represents one or more data storage medium. For example, data vault 110 may represent a system memory device like a random access memory (RAM) device, a dual in-line memory module (DIMM), a solid state drive (SSD) device, or the like, as may be provided in computer device. In another example, data vault 110 may represent a remote data store, such as a network attached storage (NAS), a storage area network (SAN), a data center-based storage array, or the like. In a particular embodiment, data vault 110 represents a data storage capacity provided by a cloud-based storage capacity or infrastructure, or multiple unrelated storage capacities provided in a multi-cloud environment.

Protected vault 110 includes protected data 112. Protected data 112 represents the individual data items, such as content items, programs or applications, user data, analytical data, or other data utilized by information handling system 100 to provide the processing functions associated with the information handling system. Protected data 112 is stored immutably in data vault 110. In particular, the immutable storage of protected data 112 ensures that, once the protected data is written to data vault 110, the protected data cannot be modified, deleted, or overwritten for a set period or without verified credentials to do such actions. In this way, the integrity and regulatory compliance of protected data 112 is ensured. The immutable storage of protected data 112 further protects the protected data from malicious activity, such as data corruption, data deletion, ransomware-based re-encryption, or other malicious activity. Further, storing protected data 112 immutably permits greater auditability for access requests to the protected data, as needed or desired. The immutability of protected data 112 may be assured through the implementation of various software mechanisms, hardware device, policies, or a combination thereof, that prevent the modification, deletion, or overwriting of the protected data, even by users who have read access to the protected data.

Data protection engine 120 represents the various software mechanisms, hardware device, policies, or a combination thereof, that prevent the modification, deletion, or overwriting of protected data 112, and includes a mutable storage device 122, an auxiliary data tagger 124, and an analytics engine 126. Current strategies for protecting protected data 112 typically involve the extensive collection of auxiliary data related to the utilization and access to the protected data. Such auxiliary data may include various logs and event information. For example, the auxiliary data may include information related to a particular element of protected data such as protected data 112, or other elements of protected data, information related to groupings of associated elements of protected data, information related to the entirety of data vault 110, or other data necessary to the protection of the protected data, as needed or desired.

Auxiliary data related to protected data 112 may include a count of read requests or a rate of read requests, a count of write requests or a rate of write requests, a date stamp for the original write of the protected data, a data size of the protected data, other information as to the origin of the protected data such as a username associated with the origin of the protected data, a program or application associated with the protected data, or other origination information, or other such information, as needed or desired. Auxiliary data related to grouping of associated protected data may include combined read or write request counts or combined read or write request rates, origination information, or other information, as needed or desired. Auxiliary data related to data vault 110 may include counts of unfulfilled access requests, data transfer bandwidths for read access request or write access requests, storage capacity of the data vault or measures of the used storage capacity of the data vault, or other information, as needed or desired.

It has been understood by the inventors of the current disclosure that the amount of available auxiliary data may exceed the actual need of data protection engine 120 to reasonably secure data vault 110 from data loss, corruption, or intrusion. That is, some elements of the auxiliary data may be understood to be more relevant to the protection of data vault 110 than other elements of the auxiliary data. For example, it may be understood that auxiliary data that is related to the origination of protected data 112 may be of less relevance to the protection of the protected data than auxiliary data that is related to read access rate information, which may in turn be of less relevance than auxiliary data that is related to read access rate information. However in the typical scheme for the protection of protected data, all of the protected data is gathered in the analyses and implementation of the protection for data vault 110. In this regard, data vault 110 is illustrated as providing raw auxiliary data to data protection engine 120. This is indicative of the entirety of the auxiliary data. Further, in the typical scheme for the protection of the protected data, the raw auxiliary data is stored immutably. In this regard, the typical scheme for the protection of protected data may be understood to be inefficient, both in terms of the storage resources needed to store the raw auxiliary data immutably, and in terms of the processing resources to analyze the raw auxiliary data to effectively protect the protected data.

In a particular embodiment, the raw auxiliary data is stored in mutable storage 122. Auxiliary data tagger 124 operates to tag the raw auxiliary data to protected data 112, to groupings of the elements of protected data, and to the usage of data vault 110. That is, each element of the raw auxiliary data is associated with one or more of protected data 112, with the groupings of the elements of protected data, and with the usage of data vault 110. Once tagged, auxiliary data tagger 124 determines the relevance of each tagged element of the raw auxiliary data to the security of the associated protected data. For example, a tagged element of the raw auxiliary data that relates to the origination of protected data 112 may be provided a relevance that is less than the relevance of a tagged element of the raw auxiliary data that relates to read accesses to the protected data, while the relevance of a tagged element of the raw auxiliary data that relates to read access requests to the protected data may be deemed to be highly relevant to the protection of the protected data.

The relevance of each tagged element of the raw auxiliary data and its associated protected data may be provided in any form, as needed or desired. For example, the relevance may be given as a score, such as on a rating of 1-10, my be given a percentage rating, may be rated in terms of ranking levels, such as a “low” ranking, a “medium” ranking, and a “high” ranking, or any other method for indicating a relevance as needed or desired. In a particular embodiment the relevance of each element of the raw auxiliary data as it relates to protected data 112, groupings of protected data, and data vault 110 may be determined based upon static rules that may be predefined, as may be determined from historical usage information or other considerations, as needed or desired.

Auxiliary data tagger 124 further operates to implement a data relevance threshold that defines the amount of the raw auxiliary data that is stored in mutable storage 122. Elements of the raw auxiliary data that have a relevance that is greater than the relevance threshold are retained in mutable storage 122, and elements of the raw auxiliary data that have a relevance that is less than the relevance threshold are discarded. In this way, the size of mutable storage does not need to be as large as would be the case if all the raw auxiliary data were stored immutably. Where a particular element of the raw auxiliary data is tagged to more than one of protected data 112, a grouping of elements of the protected data, or data vault 110, then auxiliary data tagger 124 operates to make a more elaborate evaluation of the various relevance levels in determining whether or not to retain that element of the raw auxiliary data. For example, where that element of the raw auxiliary data has a relevance that is greater than the relevance threshold for any metric, auxiliary data tagger 124 may retain that element of the raw auxiliary data, and may discard that element only when the relevance for all metrics are less than the relevance threshold. In another example, auxiliary data tagger 122 may apply another scheme for applying the relevance threshold, as needed or desired, such as a weighted average or the like. In this way, auxiliary data tagger 124 ensures that auxiliary data is only retained if the auxiliary data can be directly linked to specific changes or differences in protected data 112, groups of protected data, or data vault 110. The tagging of the auxiliary data can be provided in association with various report levels or and the tagging can be marked as anomalous when necessary.

In a particular embodiment, analytics engine 126 operates to assess changes in protected data 112 and data vault 110 in view of the tagged and retained auxiliary data to provide enhanced data security based upon the reduced set of auxiliary data stored in mutable storage 122. For example, analytics engine 126 may utilize an artificial intelligence/machine language (AI/ML) model, such as an iterative learning model or the like, to analyze the usage of data vault 110 and protected data 112 and the auxiliary data to determine the application of relevance to the tagged auxiliary data. Analytics engine 126 further operates to apply learnings from the analysis to refine auxiliary data tagger 124 to provide more efficient tagging and relevance determinations and applications of the relevance threshold.

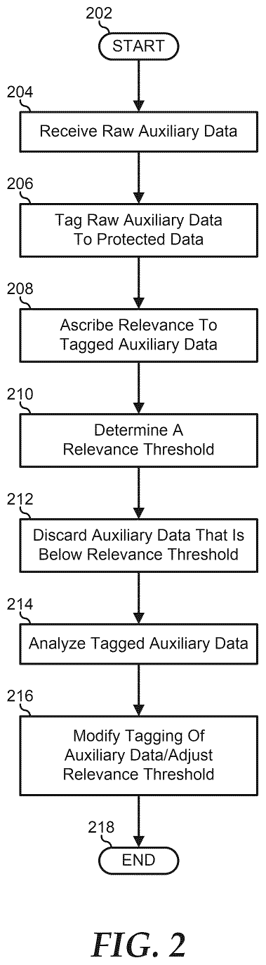

FIG. 2 illustrates a method 200 for optimizing auxiliary data in a multi-cloud environment, starting at block 202. Raw auxiliary data for a data vault is received in block 204, and the raw auxiliary data is tagged to associated protected data in the data vault in block 206. The tagged auxiliary data is ascribed a relevance to the protection of the protected data in block 208, and a relevance threshold is determined in block 210. Elements of the tagged auxiliary data that has a relevance that is less than the relevance threshold is discarded in block 212. The tagged auxiliary data is analyzed in view of the protected data and the data vault in block 214. Based on the analysis, the tagging of the auxiliary data is modified and the relevance threshold is adjusted in block 216, and the method ends at block 218.

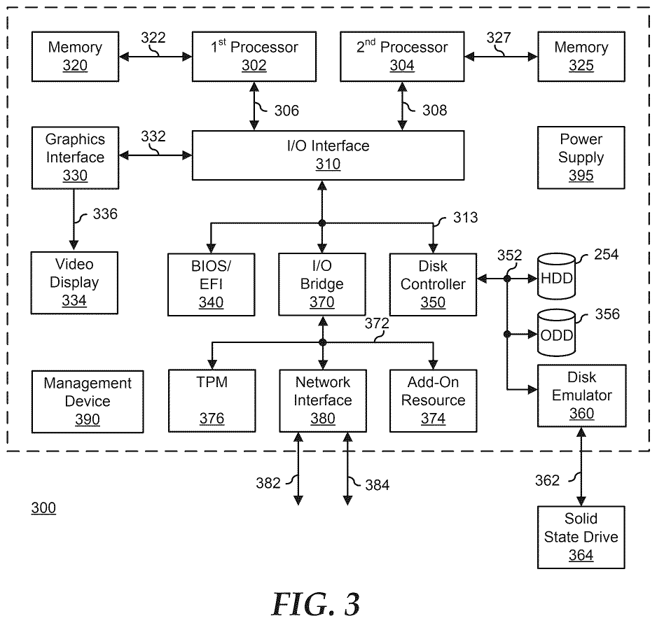

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a data vault to store protected data and to provide auxiliary data associated with the protected data; and
a processor configured to tag elements of the auxiliary data to elements of the protected data, to mark each tagged element of the auxiliary data with a relevance level that indicates a relevance of the element of the auxiliary data to the protection of the associated element of protected data, to set a relevance level threshold, to retain a first set of the tagged elements in a storage device, and to discard a second set of the tagged elements, wherein the first set of the tagged elements has relevance levels higher than the relevance level threshold, and the second set of the tagged elements has relevance levels lower than the relevance level threshold.

2. The information handling system of claim 1, wherein each element of the auxiliary data is tagged to at least one of a single element of the protected data, to a group of elements of the protected data, and to the data vault.

3. The information handling system of claim 2, wherein, when a particular element of the auxiliary data is tagged to more than one of the single element of the protected data, the group of elements of the protected data, and the data vault, the processor is further configured to retain the particular element of the auxiliary data when the relevance level for any one of the single element of the protected data, the group of elements of the protected data, and the data vault is greater than relevance level threshold.

4. The information handling system of claim 3, wherein the processor is further configured to discard the particular element of the auxiliary data when the relevance levels for all of the at least one of the single element of the protected data, the group of elements of the protected data, and the data vault are less than relevance level threshold.

5. The information handling system of claim 2, wherein, when a particular element of the auxiliary data is tagged to more than one of the single element of the protected data, the group of elements of the protected data, and the data vault, the processor is further configured to calculate a weighted average of the associated relevance levels.

6. The information handling system of claim 5, wherein the processor is further configured to retain the particular element of the protected data when the weighted average is greater than the relevance level threshold.

7. The information handling system of claim 6, wherein the processor is further configured to discard the particular element of the protected data when the weighted average is less than the relevance level threshold.

8. The information handling system of claim 1, wherein the relevance level is determined based on a predetermined criteria.

9. The information handling system of claim 8, wherein the processor is further configured to analyze the first set of tagged elements and to modify the predetermined criteria in response to the analysis.

10. The information handling system of claim 9, wherein the processor is further configured to change the relevance level threshold in response to the analysis.

11. A method, comprising:
providing, in an information handling system, a data vault to store protected data and to provide auxiliary data associated with the protected data;
tagging elements of the auxiliary data to elements of the protected data;
marking each tagged element of the auxiliary data with a relevance level that indicates a relevance of the element of the auxiliary data to the protection of the associated element of protected data;
setting a relevance level threshold;
retaining a first set of the tagged elements in a storage device; and
discarding a second set of the tagged elements, wherein the first set of the tagged elements has relevance levels higher than the relevance level threshold, and the second set of the tagged elements has relevance levels lower than the relevance level threshold.

12. The method of claim 11, wherein each element of the auxiliary data is tagged to at least one of a single element of the protected data, to a group of elements of the protected data, and to the data vault.

13. The method of claim 12 wherein, when a particular element of the auxiliary data is tagged to more than one of the single element of the protected data, the group of elements of the protected data, and the data vault, the method further comprises:
retaining the particular element of the auxiliary data when the relevance level for any one of the single element of the protected data, the group of elements of the protected data, and the data vault is greater than relevance level threshold.

14. The method of claim 13, further comprising discarding the particular element of the auxiliary data when the relevance levels for all of the at least one of the single element of the protected data, the group of elements of the protected data, and the data vault are less than relevance level threshold.

15. The method of claim 12 wherein, when a particular element of the auxiliary data is tagged to more than one of the single element of the protected data, the group of elements of the protected data, and the data vault, the method further comprises:
calculating a weighted average of the associated relevance levels.

16. The method of claim 15 further comprising retaining the particular element of the protected data when the weighted average is greater than the relevance level threshold.

17. The method of claim 16, further comprising discarding the particular element of the protected data when the weighted average is less than the relevance level threshold.

18. The method of claim 11, wherein the relevance level is determined based on a predetermined criteria.

19. The method of claim 18, further comprising:
analyzing the first set of tagged elements;
modifying the predetermined criteria in response to the analysis; and
changing the relevance level threshold in response to the analysis.

20. An information handling system, comprising:
an immutable data vault to store protected data and to provide auxiliary data associated with the protected data;
a mutable storage device to receive the auxiliary data; and
a processor configured to tag elements of the auxiliary data to elements of the protected data, to mark each tagged element of the auxiliary data with a relevance level that indicates a relevance of the element of the auxiliary data to the protection of the associated element of protected data, to set a relevance level threshold, to retain a first set of the tagged elements in the storage device, and to discard a second set of the tagged elements from the storage device, wherein the first set of the tagged elements has relevance levels higher than the relevance level threshold, and the second set of the tagged elements has relevance levels lower than the relevance level threshold.
